(19) United States
(12) Patent Application Publication
(10) Pub. No.: US 2024/0025534 A1
(43) Pub. Date: Jan. 25, 2024

(54) METHOD FOR CONTROLLING AN AIRCRAFT CONTROL ENGINE, CONTROL DEVICE AND AIRCRAFT

(71) Applicant: Safran Electronics & Defense, PARIS (FR)

(72) Inventors: Badr MANSOURI, MOISSY-CRAMAYEL (FR); Hicham JANATI IDRISSI, MOISSY-CRAMAYEL (FR); Pascal COPPÉE, MOISSY-CRAMAYEL (FR)

(73) Assignee: Safran Electronics & Defense, PARIS (FR)

(21) Appl. No.: 18/265,163

(22) PCT Filed: Dec. 2, 2021
(86) PCT No.: PCT/FR2021/052176

§ 371 Date: Jun. 2, 2023

(30) Foreign Application Priority Data
Dec. 4, 2020 (FR) 2012730

(51) Int. Cl. B64C 13/04; G05G 9/047

(52) U.S. Cl. CPC B64C 13/0421; G05G 9/047; G05G 2009/04766

(57) ABSTRACT

A method for controlling an engine, a device for controlling an engine and an aircraft, the method comprising the steps of determining a first intensity Kp, representing a stiffness, according to a physical stiffness Kss of the mechanical connection and a stiffness setpoint Kpspec to be rendered on the control column, a second intensity Kv, representing a damping, according to a physical damping fss between the control column and the engine and a damping setpoint Kvspec to be rendered on the control column, and a third intensity Ka, representing an inertia, according to a physical inertia Jss of the control column and an inertia setpoint Kaspec to be rendered on the control column.

### FIELD OF THE INVENTION

The present invention relates in general to aircraft control devices. More particularly, it relates to control devices comprising a stick with an effort feedback or a force feedback that makes it possible to restore or simulate an artificial effort which is felt by the user via the stick on which he acts.

### State of the Art

An aircraft control device generally comprises a control stick rotatably mounted along an axis called roll axis and an axis called pitch axis, these two axes being orthogonal to each other. Devices of the “joystick” type are most often encountered.

Depending on the position of the stick along the two axes, the aircraft control device transmits movement commands to members for piloting the aircraft.

An effort feedback control device or an effort feedback haptic device is a device that comprises an element used for the control. This element is activated by the user. This effort feedback control device is configured to generate an artificial effort felt by the user, which opposes the motion applied by the user's hand.

In the field of aeronautics, control devices for an aircraft are known which allow an effort feedback to the user. These devices generally take the form of a stick, referred to as active stick.

These control devices make it possible, for example, to control an airplane or a helicopter, more particularly they make it possible to control control surfaces or one or several motors of the aircraft. This control is done by the action of a movement of the stick, generally a rotation, about an axis fixed on a support. This action is performed by the user or the pilot.

The effort feedback via the stick is generally achieved by a motor connected to the stick, to apply an artificial effort. This artificial effort is obtained by a torque generated by the motor on the stick. This artificial effort makes it possible to restore a stiffness and/or a damping. The intensity of the artificial effort to be applied is determined according to an angular position of the stick or of the motor used to control the stick, measured by a position sensor.

For a stiffness-type effort, the intensity depends of the deviation between the angular position of the stick and a reference angular position. For an effort of the damping type, the amplitude depends of a speed of rotation of the stick (obtained by derivation of the angular position).

The control devices of the state of the art restoring a stiffness and a damping have some limitations:
they have very limited stability margins, particularly in situations in which the stiffness type effort is high compared to the damping type effort,
they do not allow the user to feel an inertia type effort, that is to say which represents the inertia of the aircraft.

Control devices which use an effort sensor are also known. Based on the information provided by this effort sensor, these control devices will restore an effort feedback by an effort servo-control on the stick. These devices have the disadvantage of requiring an effort sensor in addition to the position sensor, which complicates the control device, increases the risk of failure and makes the control device more expensive.

The present invention thus relates to an aircraft control device which does not have these different limitations.

### DISCLOSURE OF THE INVENTION

To this end, a method for controlling a motor of an aircraft control device is provided according to the invention. The device includes an aircraft control stick. The stick is connected by a mechanical connection to a shaft of the motor. The method comprises a step of determining a first intensity Kp representing a stiffness depending of a physical stiffness Kₛₛ of said mechanical connection and of a stiffness setpoint Kp_{spec} to be restored on the stick, a second intensity Kv representing a damping depending of a physical damping fₛₛ between the stick and the motor and of a damping setpoint Kv_{spec} to be restored on the stick, and a third intensity Ka representing an inertia depending of a physical inertia Jₛₛ of the stick and of an inertia setpoint Ka_{spec} to be restored on the stick. The method also comprises a step of calculating a torque to be controlled on the shaft of the motor by linear combination of an angular position of the shaft relative to a stator of the motor, of a speed of rotation of the shaft relative to the stator and of an acceleration of the shaft relative to the stator with respectively said first, second and third intensities Kp, Kv and Ka.

Thus, this control device allows the user to feel an inertia type effort in addition to a stiffness type effort and to a damping type effort, based on information derived from the angular position provided by a simple position sensor.

In one embodiment, the determination step uses the formula:

$$Kp = {R}^{2} \frac{{K}_{ss} {Kp}_{spec}}{( \frac{1}{{r}_{p}} {K}_{ss} - {Kp}_{spec} )}$$

where:

R is a mechanical connection reduction ratio,

Kₛₛ is the physical stiffness Kₛₛ of the mechanical connection,

rₚ is a radius of the stick, and

Kp_{spec} is the stiffness setpoint to be restored on the stick.

In one embodiment, the determination step uses the formula:

$$Kv = {R}^{2} ( {r}_{p} {{Kv}_{spec} ( \frac{{K}_{ss} + \overline{K} p}{{K}_{ss}} )}^{2} - {( \frac{\overline{K} p}{{K}_{ss}} )}^{2} {f}_{ss} )$$

where:

R is a mechanical connection reduction ratio,

rₚ is a radius of the stick,

fₛₛ represents the physical damping between the stick and the motor, and

Kv_{spec} is the damping setpoint to be restored on the neck.

In one embodiment, the determination step uses the formula:

$$Ka = ( {r}_{p} . {Ka}_{spec} - {J}_{ss} ) {( R \frac{{K}_{ss} + \overline{K} p}{{K}_{ss}} )}^{2} + \frac{{{R}^{2} ( {f}_{ss} \overline{K} p - \overline{K} {vK}_{ss} )}^{2}}{{K}_{ss}^{2} ( {K}_{ss} + \overline{K} p )} - {J}_{mot}$$

where:

R is a mechanical connection reduction ratio,

rₚ is a radius of the stick,

Jₛₛ represents the physical inertia of the stick,

Jₘₒₜ represents the physical inertia of the shaft of the motor, and

Ka_{spec} is the inertia setpoint to be restored on the stick.

In one embodiment, the method comprises a step of receiving the angular position of the motor shaft, the angular position being provided by a position sensor, the speed being obtained by derivation of the angular position and the acceleration being obtained by second derivation of the angular position.

In one embodiment, the method comprises a step of receiving the angular position of the shaft of the motor, the angular position being received from a position sensor (CPO). The speed is determined by derivation of the angular position and the acceleration is determined by second derivation of the angular position.

In one embodiment, the stiffness setpoint, the damping setpoint and the inertia setpoint are determined from respectively the angular position, the speed and the acceleration.

In one embodiment, the method further comprises a step of controlling the motor, the control step comprising a determination of an electric current setpoint from the torque, and a servo-control of this current setpoint using a current corrector and a measurement of an electric current at the terminals of the motor.

An aircraft control device is also provided according to the invention, the device comprising a stick, a motor comprising a shaft and a stator, the shaft being rotatably mounted in the stator, and a processing unit. The shaft is connected to the stick by a mechanical connection, the stick is configured to control the aircraft, the processing unit is configured for the implementation of the control method.

In one embodiment, the control device further comprises a sensor configured to determine an angular position of the shaft relative to the stator.

An aircraft comprising the control device is also provided according to the invention.

### DESCRIPTION OF THE FIGURES

Other characteristics, aims and advantages of the invention will emerge from the following description, which is purely illustrative and not limiting and which must be read in relation to the appended drawings in which:

FIG. 1 represents an aircraft control device of the invention.

FIG. 2 represents the monitoring method of the invention.

FIG. 3-a represents a setpoint stiffness Kp_{spec} according to the angle of the motor and FIG. 3-b represents a setpoint damping Kv_{spec} according to the speed of rotation of the motor.

FIG. 4 represents the block diagram of the mechanical and electrical chain of the invention.

FIG. 5 represents a model used by the motor control device of the invention.

### DETAILED DESCRIPTION OF THE INVENTION

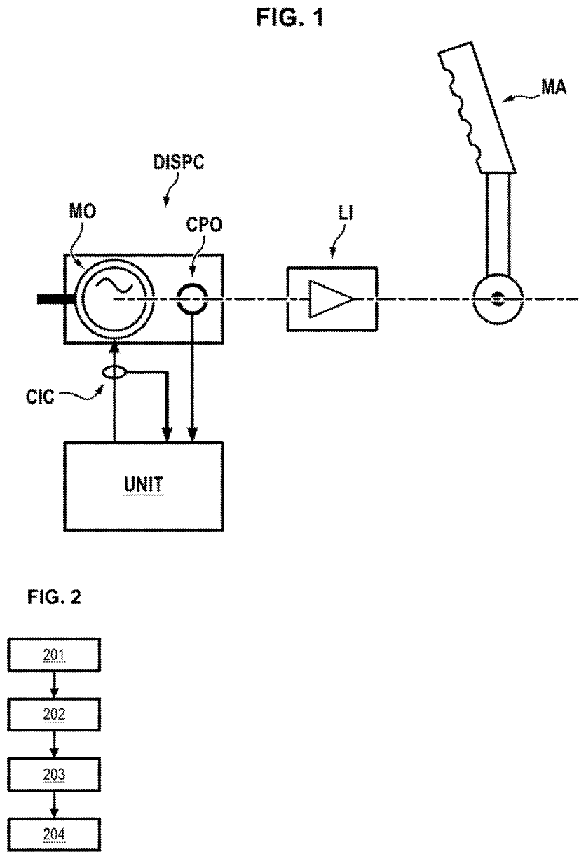

FIG. 1 represents the control device DISPC of the invention. This control device DISPC comprises a stick MA.

The stick MA is rotatably mounted along an axis called roll axis and an axis called pitch axis, these two axes being orthogonal to each other.

For simplification, only one of the axes is represented in FIG. 1.

For each of the two axes, the control device DISPC comprises a motor MO, an angular position sensor CPO, a sensor CIC of an intensity of an electric current provided to the motor MO.

The motor MO, the angular position sensor CPO and the sensor CIC are similar for both axes. In the following, the operation of the control device DISPC along a single axis will be described. The operation on the other axis is identical.

The control device DISPC also comprises a processing unit UNIT.

This control device DISPC makes it possible to monitor the control surfaces of an aircraft or to monitor the motors(s) of the aircraft.

The motor MO comprises a shaft or rotor and a stator. The shaft and the stator are coaxial. The shaft and the stator have coils for one and permanent magnets for the other. The passage of an electric current in the coils causes a rotation of the shaft relative to the stator. For simplification, the expression “angular position of the motor MO” will be used to designate the angular position of the shaft relative to the stator.

The electric motor MO can be a single-phase motor (motor with limited displacement) or a permanent magnet synchronous motor.

The angular position sensor CPO is configured to determine an angular position of the motor, it is advantageously coupled directly on the motor shaft.

The stick MA and the motor MO are interconnected by a mechanical connection LI. More specifically, the shaft of the motor MO is connected to the mechanical connection LI which is connected to the stick MA.

The mechanical connection LI has a reduction ratio R. By reduction ratio R, it is meant that, when the electric motor MO and more particularly its shaft rotates by an angle Θ, then the stick rotates by an angle R*Θ.

The reduction ratio R can vary as a function of the angular position of the motor MO in a non-linear manner. In this case, R represents its linearized value around a given angle Θ.

The processing unit UNIT is configured to receive from the position sensor CPO the angular position of the motor MO. The processing unit is configured to receive from the sensor CIC the intensity of the electric current measured on electric terminals of the motor MO. The processing unit UNIT is configured to pilot the motor in current from the setpoints of a current which depends on the effort to be applied.

The processing unit UNIT also comprises a current corrector (not represented in FIG. 1) which, after processing, provides a signal with pulses whose duty cycle can vary (PWM Pulse Width Modulation) to the power bridge which converts the pulses into a voltage to be applied to the electric terminals of the motor MO in order to deliver the electric current to the image of the required effort.

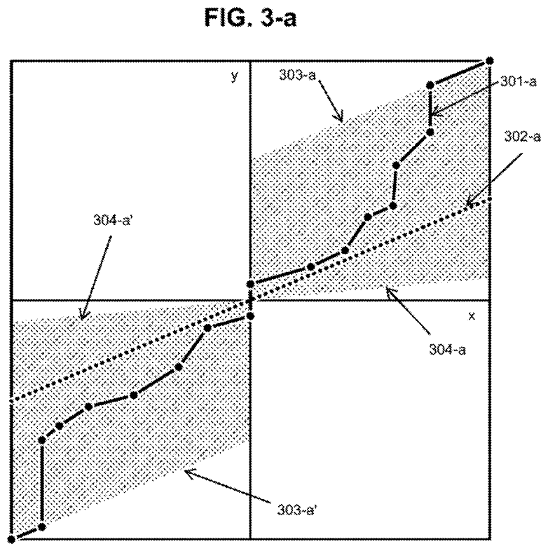

The processing unit UNIT is configured for the implementation of a control method represented in FIG. 2. This method makes it possible to control the motor MO connected to the stick MA so that the stick MA provides an effort that will be felt by the user.

This method comprises:
a first step 201 of receiving the motor angular position MO and determining a first derivative of the angular position and a second derivative of the angular position;
a second step 202 of determining:
   a first intensity Kp representing a stiffness depending of a physical stiffness of the mechanical connection LI and of a stiffness setpoint Kp_{spec} to be restored on the stick MA,
   a second intensity Kv representing a damping depending of a physical damping fₛₛ between the stick MA and the motor MO and of a damping setpoint Kv_{spec} to be restored on the stick, and
   a third intensity Ka representing an inertia depending of a physical inertia of the stick and of an inertia setpoint Ka_{spec} to be restored on the stick (MA).
a step 203 of calculating a torque, by linear combination of an angular position of the shaft relative to a stator of the motor, of the speed of rotation of the shaft relative to the stator of the motor and of the acceleration of the shaft relative to the stator of the motor with respectively the first, second and third intensities Kp, Kv and Ka, and
a step 204 of controlling the motor MO so that the motor MO generates the torque and the three efforts on the shaft.

The angular position of the shaft of the motor MO relative to the stator of the motor MO is obtained from the angular position sensor CPO.

The first derivative of the angular position of the motor MO corresponds to a speed of rotation of the shaft of the motor MO relative to the stator of the motor MO.

The second derivative of the angular position of the motor MO corresponds to an acceleration of the rotation of the shaft of the motor MO relative to the stator of the motor MO.

The determination of the first derivative of the angular position and of the second derivative of the angular position can be made by algorithms in the state of the art well known to those skilled in the art and which consist in prforming a linear or non-linear derivation, to result in values of the speed of rotation of the motor MO and of the acceleration of the motor MO which are not noisy.

The second determination step 202 allows the determination of three efforts that the motor MO must apply on the stick MA, via the mechanical connection LI. Each of the three efforts constitutes an elementary component of an overall effort. The overall effort applied on the stick MA by the motor MO is therefore the sum of these three efforts. This global effort is felt by the user when he moves the stick MA.

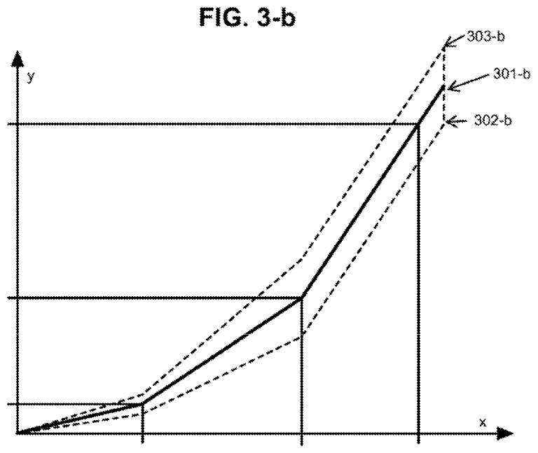

The first of the three efforts is an effort restoring a stiffness of the stick MA. This first effort is generated by the motor MO. This first effort is proportional to an angular deviation between the angular position of the shaft of the motor MO relative to the stator of the motor MO and an angular position called anchor position. This anchor position is the position to which the stick MA returns when it is not subjected to an action from the user. The first intensity Kp is determined according to the stiffness setpoint Kp_{spec} that the stick MA must restore. The stiffness to be restored is the stiffness that the user must feel when he uses the stick MA. This stiffness setpoint Kp_{spec} can be a gain which presents the ratio between the generated effort and the angular deviation, this stiffness setpoint Kp_{spec} can be variable according to the angular deviation, as illustrated in FIG. 3-a.

In FIG. 3-a, the abscissa axis x represents the position of the stick varying from a negative position of movement of the stick to a positive position of movement of the stick. The ordinate axis y represents the stiffness setpoint Kp_{spec}. The dotted curve 302-a represents the effect of a passive spring type effort. The solid curve 302-a represents the stiffness setpoint Kp_{spec}. This solid curve presents several areas with different slopes. The circles on the solid curve 302-a represent the slope failures. The limits 303-a and 303-a′ of the hatched area represent the upper limit of the evolution of the curve of the setpoint. The limits 304-a and 304-a′ of the hatched area represent the optional lower limit of the evolution of the curve of the setpoint.

The second of the three efforts is an effort restoring a damping of the stick MA. This second effort is generated by the motor MO. This second effort is proportional to the speed of rotation of the shaft of the motor MO relative to the stator of the motor MO. The second intensity Kv is determined according to the damping setpoint Kv_{spec} that the stick MA must restore. The damping to be restored is the damping that the user must feel when using the stick MA. This damping setpoint Kv_{spec} can be a gain or a function dependent on the speed of rotation of the motor MO, as illustrated in FIG. 3-b.

In FIG. 3-b, the abscissa axis x represents the speed of movement of the stick and the ordinate axis y represents the damping setpoint Kv_{spec}. The curve 301-b representing this setpoint is comprised between a lower limit curve 302-b and an upper limit curve 303-b. Moreover, this curve 301-b has several areas with different slopes.

The third of the three efforts is an effort restoring an inertia of the stick MA. This third effort is generated by the motor MO. This third effort is proportional to the acceleration of the rotation of the shaft of the motor MO relative to the stator of the motor MO. The third intensity K a is determined according to the inertia setpoint Ka_{spec} that the stick MA must restore. The inertia to be restored is the inertia that the user must feel when using the stick MA. This inertia setpoint Ka_{spec} can be a simple gain, or a non-linear law depending on the acceleration of the rotation of the motor MO. It can also be indexed by the speed of rotation of the motor MO or the angular position of the motor MO.

The intensities Kp, Ka and Kv are determined by using a transfer function HpSS(s) connecting the effort Fp(s) felt by the user on the stick MA and the angle Θₘₒₜ(s) of the shaft of the motor MO relative to the stator of the motor MO.

This transfer function is modeled by the following function:

$$HpSS = \frac{Θ mot ( s )}{Fp ( s )} = - {r}_{p} \frac{( {\overline{J}}_{mot} {s}^{2} + ( {f}_{ss} + \overline{K} v ) s + {K}_{ss} + \overline{K} p )}{{\overline{J}}_{mot} {J}_{ss} {s}^{4} + ( {J}_{ss} {\overline{K}}_{v} + {\overline{J}}_{mot} {f}_{ss} + {J}_{ss} {f}_{ss} ) {s}^{3} + ( {\overline{J}}_{mot} {K}_{ss} + {J}_{ss} \overline{K} p + \overline{K} {vf}_{ss} + {J}_{ss} {K}_{ss} ) {s}^{2} + ( {K}_{ss} {\overline{K}}_{v} + {\overline{K}}_{p} {f}_{ss} ) s + \overline{K} {pK}_{ss}}$$

where:

Jₘₒₜ is a predetermined parameter of the inertia of the shaft of the motor MO

Jₛₛ is a predetermined parameter of the inertia of the connection LI between the motor MO and the stick MA

fₛₛ is a predetermined parameter of the physical damping between the motor MO and the stick MA

Kₛₛ is a predetermined parameter of the stiffness of the connection LI connecting the motor MO and the stick MA

rₚ is the radius of the stick

fₛₛ is expressed in Newton*meter/radian/second (N*m/rad/s).

Kₛₛ is expressed in Newton*meter/radian (N*M/rad).

Jₘₒₜ is expressed in meter*kilogram\hat{ }2 (m*kg²).

Jₛₛ is expressed in meter*kilogram\hat{ }2 (m*kg²).

By stick radius rₚ it is meant the distance between an axis of rotation of the stick MA and a point of application of the effort by the pilot on the stick MA.

Kp_{obt} is an intensity of the stiffness obtained and felt by the user at the level of the stick MA. Kp_{obt} is equal to the inverse of the static gain of the transfer function HpSS(s).

$$\frac{1}{{Kp}_{obt}} = \vert {lim}_{s \to 0} ( HpSS ( s ) ) \vert = \vert - {r}_{p} \frac{( {K}_{ss} + \overline{K} p )}{( \overline{K} p * {K}_{ss} )} \vert$$

$$Thus :$$

$${Kp}_{obt} = \frac{( \overline{K} p * {K}_{ss} )}{( {K}_{ss} + \overline{K} p ) {r}_{p}}$$

The previous formula shows that the stiffness felt by the user is the combination of two stiffnesses in series, namely the stiffness generated by the motor and the stiffness of the mechanical connection LI between the motor MO and the stick MA. Thus, to have a stiffness felt by the user at the level of the stick whose intensity is equal to Kp_{spec}, it is necessary that the motor MO generates a first effort, of the stiffness type, whose intensity is equal to:

$$Kp = {R}^{2} \frac{{K}_{ss} {Kp}_{spec}}{( \frac{1}{{r}_{p}} {K}_{ss} - {Kp}_{spec} )}$$

In the previous formula

$${\overline{K}}_{p} = \frac{{K}_{p}}{{R}^{2}} .$$

Kv_{obt} is an intensity of the damping obtained and felt by the user at the level of the stick MA. Kv_{obt} is equal to the first-order static gain of the HpSS(s) function, which can be calculated from the following assumption valid at low frequency:

$$\frac{1}{HpSS ( s )} \approx {Kp}_{obt} + {Kv}_{obt} s$$

Or exactly:

$${Kv}_{obt} = \vert {lim}_{s \to 0} ( \frac{1}{S} ( \frac{1}{HpSS ( S )} - {Kp}_{obt} ) ) \vert$$

By setting

$${HpBF}_{v} ( s ) = \frac{1}{S} ( \frac{1}{HpSS ( s )} - {Kp}_{obt} )$$

we get:

$${HpBF}_{v} ( S ) = \frac{1}{S} ( \frac{{\overline{J}}_{mot} {J}_{ss} {s}^{4} + ( {J}_{ss} \overline{K} v + {\overline{J}}_{mot} {f}_{ss} + {J}_{ss} {f}_{ss} ) {s}^{3} + ( {\overline{J}}_{mot} {K}_{ss} + {J}_{ss} \overline{K} p + \overline{K} {vf}_{ss} + {J}_{ss} {K}_{ss} ) {s}^{2} + ( {K}_{ss} \overline{K} v + \overline{K} {pf}_{ss} ) s + \overline{{K}_{p}} * {K}_{ss}}{- {r}_{p} ( {\overline{J}}_{mot} {s}^{2} + ( {f}_{ss} + \overline{K} v ) s + {K}_{ss} + \overline{K} p )} ) - \frac{( \overline{K} p {K}_{ss} )}{( {K}_{ss} + \overline{K} p ) {r}_{p}} )$$

By approaching s to 0, we get:

$${HpBF}_{v} ( 0 ) = - \frac{1}{{r}_{p}} ( \frac{{K}_{ss}^{2} \overline{K} v + {f}_{ss} \overline{K} {p}^{2}}{{( {K}_{ss} + \overline{K} p )}^{2}} )$$

The intensity of the damping obtained and felt by the user at the level of the stick MA is therefore given by the equation:

$${Kv}_{obt} = \frac{1}{{r}_{p}} ( {( \frac{{K}_{ss}}{{K}_{ss} + \overline{K} p} )}^{2} \overline{K} v + {( \frac{\overline{K} p}{{K}_{ss} + \overline{K} p} )}^{2} {f}_{ss} )$$

The damping felt by the user is therefore the sum of the damping generated by the motor and of the damping of the physical connection LI between the stick MA and the motor MO. This sum is weighted by the stiffness of the physical connection LI and by the stiffness generated by the motor MO. Thus, to have a damping felt by the user at the level of the stick with the intensity Kv_{obt} equal to Kv_{spec}, it is necessary that the motor MO generates a second effort whose intensity Kv is equal to:

$$Kv = {R}^{2} ( {r}_{p} {{Kv}_{spec} ( \frac{{K}_{ss} + \overline{K} p}{{K}_{ss}} )}^{2} - {( \frac{\overline{K} p}{{K}_{ss}} )}^{2} {f}_{s} )$$

Ka_{obt} is an intensity of the inertia obtained and felt by the user at the level of the stick MA. This intensity Ka_{obt} is equal to the second-order static gain of the function HpSS(s). This static gain is calculated by taking the following assumption valid at low frequency:

$$\frac{1}{HpBF ( S )} \approx {Kp}_{obt} + {Kv}_{obt} s + {Ka}_{obt} {s}^{2}$$

The intensity Ka_{obt} of the inertia obtained and felt by the user at the level of the stick MA is therefore:

$${Ka}_{obt} \approx \frac{1}{{s}^{2}} ( \frac{1}{HpSS ( S )} - {Kp}_{obt} - {Kv}_{obt} * s )$$

We have:

$${Ka}_{obt} = \vert {lim}_{s \to 0} ( \frac{1}{{s}^{2}} ( \frac{9}{HpSS ( s )} - {Kp}_{spec} - {Kv}_{spec} s ) ) \vert$$

After development, we find:

$${Ka}_{obt} = \vert - \frac{1}{{r}_{p}} ( {J}_{ss} + {\overline{J}}_{mot} \frac{{K}_{ss}^{2}}{{( {K}_{ss} + \overline{K} p )}^{2}} - \frac{{( {f}_{ss} \overline{K} p - \overline{K} {vK}_{ss} )}^{2}}{{( {K}_{ss} + \overline{K} p )}^{3}} ) \vert$$

For reasons of physical feasibility, we know that:

$${J}_{ss} = {\overline{J}}_{mot} \cdot \frac{{K}_{ss}^{2}}{{( {K}_{ss} + \overline{K} p )}^{2}} > \frac{{( {f}_{ss} \overline{K} p - \overline{K} {vK}_{ss} )}^{2}}{{( {K}_{ss} + \overline{K} p )}^{3}}$$

And as the assumed input of the system is a force, the intensity Ka_{obt} is expressed in m·Kg2 and is given by the following equation:

$${Ka}_{obt} = {J}_{ss} + {\overline{J}}_{mot} \cdot \frac{{K}_{ss}^{2}}{{( {K}_{ss} + \overline{K} p )}^{2}} - \frac{{( {f}_{ss} \overline{K} p - \overline{K} {vK}_{ss} )}^{2}}{{( {K}_{ss} + \overline{K} p )}^{3}}$$

This equation clearly shows the impact of the restored stiffness, the restored damping and the restored inertia on the inertia restored at the level of the stick MA by the user. However, when the physical system is infinitely rigid, i.e, Kₛₛ→∞, the inertia felt by the user is only the sum of the inertia of the mechanical connection LI and of the inertia of the motor MO. Thus, the effect of the artificial stiffness on the global inertia is canceled.

Thus, to have an inertia felt by the user whose intensity Ka_{obt} is equal to Ka_{spec}, the intensity Ka of the inertia to be restored, that the motor MO must generate, must be equal to:

$$Ka = ( {r}_{p} {Ka}_{spec} - {J}_{ss} ) {( R \frac{{K}_{ss} + \overline{K} p}{{K}_{ss}} )}^{2} + \frac{{{R}^{2} ( {f}_{ss} \overline{K} p - \overline{K} {vK}_{ss} )}^{2}}{{K}_{ss}^{2} ( {K}_{ss} + \overline{K} p )} - {J}_{mot}$$

Thus the second determination step 202 makes it possible to determine the intensities (Kp, Kv and Ka) of three efforts that the motor MO must apply in order to actuate the stick MA in motion and so that the user feels, via the stick MA, three efforts restoring a stiffness of the stick MA, a damping of the stick MA and an inertia of the stick MA and of respective setpoints s Kp_{spec}, Kv_{spec}, and Ka_{spec}.

Kp and Kp_{spec} are expressed in Newton*meter/radian (N*m/rad).

Kv and Kv_{spec} are expressed in Newton*meter/radian/second (N*m/rad/s).

Ka and Ka_{spec} are expressed in meter*kilogram\hat{ }2 (m*kg\hat{ }2).

It can be noted that the transfer function connecting the effort of the user on the stick and the angle of the stick can be expressed at low frequency in the following form:

$$HpBF = \frac{{θ}_{ss} ( s )}{Fp ( s )} \approx \frac{1 / {Kp}_{spec}}{\frac{{Ka}_{spec}}{{Kp}_{spec}} {s}^{2} + \frac{{Kv}_{spec}}{{Kp}_{spec}} s + 1}$$

This low-frequency model can be represented by a second-order function of canonical form H_{Template} of the following form:

$${H}_{Template} ( s ) = \frac{1 / K}{\frac{1}{{( 2 π f )}^{2}} {s}^{2} + \frac{2 ξ}{( 2 π f )} s + 1}$$

where f is the cutoff frequency, ζ is a parameter of the desired damping and 1/K is a static gain. These elements can be expressed as a function of the stiffness setpoint Kp_{spec} that the stick MA must restore, of the damping setpoint Kv_{spec} that the stick MA must restore and of the inertia setpoint Ka_{spec} that the stick MA must restore:

$$f = \frac{1}{2 π} \sqrt{\frac{{Kp}_{spec}}{{Ka}_{spec}}} \\ ξ = π f \frac{{Kv}_{spec}}{{Kp}_{spec}} \\ or ξ = \frac{1}{2} \frac{{Kv}_{spec}}{\sqrt{{Kp}_{spec} {Ka}_{spec}}} \\ K = \frac{1}{{Kp}_{spec}}$$

In one embodiment, the method comprises a step of determining the stiffness setpoint Kp_{spec} that the stick MA must restore, the damping setpoint Kv_{spec} that the stick MA must restore and the inertia setpoint Ka_{spec} that the stick MA must restore, from the cutoff frequency f, from the desired damping parameter and from the static gain 1/K. This is achieved by successively using the following formulas:

$${Kp}_{spec} = \frac{1}{K} , \\ {Kv}_{spec} = ξ \frac{{Kp}_{spec}}{π f} \\ {Ka}_{spec} = \frac{{Kp}_{spec}}{{( 2 π f )}^{2}}$$

ζ is expressed in Newton*meter/radian (N*m/rad).

f is expressed in hertz (Hz).

K is expressed in radian/Newton*meter (rad/N*m).

The step 203 of calculating the torque that the motor must generate from the three efforts is carried out by linear combination of the angular position, of the first derivative of the angular position and of the second derivative of the angular position with the intensities Ka, Kp and Kv associated with the three efforts that the motor MO must generate via its shaft.

In one embodiment, three torques are determined, the first as a function of the position, the second as a function of the speed and the third as a function of the acceleration, and these three torques are summed.

In the case where the setpoints are variable (non-linear artificial law), a lookup-table of the intensity of the efforts is used, which makes it possible to determine the intensities Kp, Kv and Ka according respectively to the angular position of the shaft, to the speed of rotation of the shaft and to the acceleration of the rotation of the shaft.

The step 204 of controlling the motor from the determined torque comprises a first step of determining a setpoint of an electric current making it possible to supply the electric motor MO so that it provides, on its shaft, the torque determined in the calculation step 203. This step also comprises the servo-control of this current setpoint using a current corrector and the measurement of the electric current at the terminals of the motor MO.

Thus, the sum of the three efforts constitutes the intensity of the torque that the motor MO must generate. More specifically, the value of the torque that the motor must generate depends on the intensities of the efforts (stiffness, damping and inertia) to be applied at the level of the stick. For example, if a pure stiffness is to be restored, the effort to be applied at the level of the stick MA is Ka*O. This torque intensity is transformed into a current setpoint by using either a linear relationship via the motor torque constant or a non-linear relationship between the torque and the current defined by the manufacturer according to the intrinsic characteristics of the motor MO. Then, this current setpoint is made available to the block 303 enabling the servo-control of the voltage of the electric current delivered at the terminals of the motor MO.

This determination of the intensity of the current is carried out based on the characteristics of the control device DISP and particularly of the electric motor MO. This determination of the intensity can be a linear law in the ideal case or a non-linear law taking into account the magnetic saturation, the temperature, etc.

Following the determination of the intensity of the electric current, a feedback loop allows a monitoring of the setpoint of the current intensity. This feedback loop uses the following elements:
the sensor CIC of the intensity of the current delivered to the motor,
the conditioning system making it possible to determine the duty cycle of the electric current supplying the motor MO,
the current corrector making it possible to deliver a control voltage which is transformed into a variable duty cycle, depending on the voltage level,
the power bridge making it possible to deliver the voltage to be applied at the terminals of the electric motor according to the duty cycle calculated by the current corrector, and
the electric motor receiving a voltage from the power bridge.

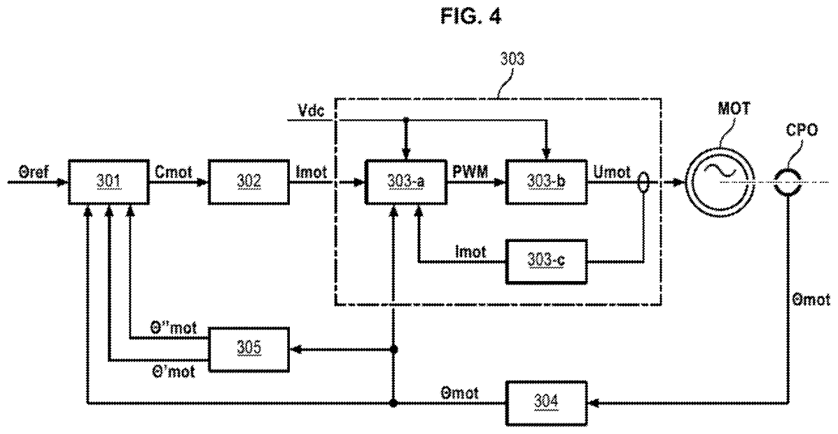

FIG. 4 represents in another way the device for controlling DISPC the motor MO. In this figure Θmot represents the angular position of the motor MO, Θ′mot represents the angular speed of the motor MO and Θ″mot represents the angular acceleration of the motor MO. Θref represents the position of the stick at rest. The block 301 is the block making it possible to determine the intensities of the three efforts that the motor must generate. The block 302 is the block making it possible to determine the equivalence between the electric current setpoint Imot and the setpoint of the motor torque Cmot. The block 303 is the block enabling the servo-control of the electric current delivered at the terminals of the motor MO as a function of the intensity Imot of the electric current making it possible to generate the torque Cmot. The block 303-a is the current loop which makes it possible, from the intensity of the electric current Imot to be delivered, to determine a duty cycle PWM of the voltage Vdc delivered to the motor MO. The block 303-b is the power bridge delivering a voltage at the terminals of the motor MO from the duty cycles PWM. The block 303-c is the electric current sensor delivering the measurement of the electric current circulating in the motor MO. The block 304 allows the processing of the signal delivered by the position sensor COP in order to obtain the angular position Θmot of the motor MO. The block 305 is the Kalman filtering making it possible to obtain Θ′mot and Θ″mot from Θmot.

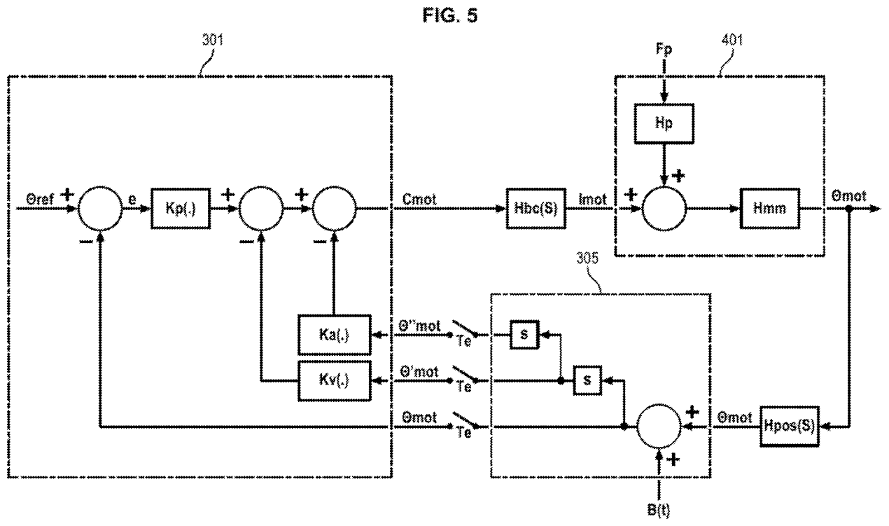

Thus, the control method uses a model as represented in FIG. 5. This figure, Hbc represents the transfer function of the current loop and the transfer function between the torque Cmot that the motor MO must generate by and the intensity Imot of the electric current at the terminals of the motor MO. Hpos represents the transfer function of the position sensor. Hp represents the transfer function between the pilot effort and the part of the effort on the stick MA generated by the motor MO. Hmm represents the transfer function between the resulting effort on the stick MA generated by the user and the motor MO and the position of the motor MO. This figure Θmot represents the angular position of the motor MO, Θ′mot represents the angular speed of the motor MO and Θ″mot represents the angular acceleration of the motor MO. Θref represents the position of the stick at rest. As in FIG. 3, the block 301 is the block making it possible to determine the intensities of the three efforts that the motor must generate. The block 401 represents the mechanical chain consisting of the motor MO and its shaft, of the stick MA and of the connection between the shaft and the stick MA and the different parameters of stiffness, damping and inertia of these elements. As in FIG. 3, the block 305 is the Kalman filtering.

1. A method of controlling a motor of an aircraft control device:
determining a first intensity representing a stiffness depending of a physical stiffness of a mechanical connection and of a stiffness setpoint to be restored on a stick of the aircraft control device, the stick being connected by the mechanical connection to a shaft of the motor;
determining a second intensity representing a damping depending of a physical damping between the stick and the motor and of a damping setpoint to be restored on the stick;
determining a third intensity representing an inertia depending of a physical inertia of the stick and of an inertia setpoint to be restored on the stick; and
calculating a torque to be controlled on the shaft of the motor by linear combination of an angular position of the shaft relative to a stator of the motor, of a speed of rotation of the shaft relative to the stator and of an acceleration of the shaft relative to the stator with respectively the first intensity, the second intensity and the third intensity.

2. The method according to claim 1, wherein:
$$Kp = {R}^{2} \frac{{K}_{ss} {Kp}_{spec}}{( \frac{1}{{r}_{p}} {K}_{ss} - {Kp}_{spec} )}$$
where:
Kp is the first intensity,
R is a mechanical connection reduction ratio,
Kₛₛ is the physical stiffness of the mechanical connection,
rₚ is a radius of the stick, and
Kp_{spec} is the stiffness setpoint to be restored on the stick.

3. The method according to claim 1, wherein:
$$Kv = {R}^{2} ( {r}_{p} {{Kv}_{spec} ( \frac{{K}_{ss} + \overline{K} p}{{K}_{ss}} )}^{2} - {( \frac{\overline{K} p}{{K}_{ss}} )}^{2} {f}_{ss} )$$
where:
Kv is the second intensity,
R is a mechanical connection reduction ratio,
rₚ is a radius of the stick,
fₛₛ is the physical damping between the stick and the motor, and
Kv_{spec} is the damping setpoint to be restored on the stick.

4. The control method according to claim 1, wherein:
$$Ka = ( {r}_{p} . {Ka}_{spec} - {J}_{ss} ) ( R \frac{{K}_{ss} + \overline{K} p}{{K}_{ss}} ) + \frac{{{R}^{2} ( {f}_{ss} \overline{K} p - \overline{K} {vK}_{ss} )}^{2}}{{K}_{ss}^{2} ( {K}_{ss} + \overline{K} p )} - {J}_{mot}$$
where:
Ka is the third intensity,
R is a mechanical connection reduction ratio,
rₚ is a radius of the stick,
Jₛₛ is the physical inertia of the stick,
Jₘₒₜ is a physical inertia of the shaft of the motor and
Ka_{spec} is the inertia setpoint to be applied on the stick.

5. The method according to claim 1, comprising receiving the angular position of the shaft of the motor from a position sensor, wherein the speed of rotation of the shaft relative to the stator is determined by derivation of the angular position and the acceleration of the shaft relative to the stator is determined by second derivation of the angular position.

6. The method according to claim 1, wherein the stiffness setpoint, the damping setpoint and the inertia setpoint are determined from respectively the angular position, the speed and the acceleration, respectively.

7. The method according to claim 1, further comprising:
determining an electric current setpoint from the torque, and
regulating the electric current setpoint using a current corrector and a measurement of an electric current at terminals of the motor.

8. An aircraft control device, the device comprising:
a stick configured to control an aircraft,
a motor comprising a shaft and a stator, the shaft being rotatably mounted in the stator, and the shaft being connected to the stick by a mechanical connection,
a processing unit,
configured to determine:
a first intensity representing a stiffness depending of a physical stiffness of the mechanical connection and of a stiffness setpoint to be restored on the stick,
a second intensity Kv representing a damping depending of a physical damping between the stick and the motor and of a damping setpoint to be restored on the stick, and
a third intensity Ka representing an inertia depending of a physical inertia of the stick and of an inertia setpoint to be restored on the stick; and
to calculate a torque to be controlled on the shaft of the motor by linear combination of an angular position of the shaft relative to the stator of the motor, of a speed of rotation of the shaft relative to the stator and of an acceleration of the shaft relative to the stator with respectively the first intensity, the second intensity and the third intensity.

9. The control device according to claim 8, further comprising a sensor configured to determine the angular position of the shaft relative to the stator.

10. An aircraft comprising the control device of claim 8.

11. An aircraft comprising the control device of claim 9.
